(19) United States
(12) Patent Application Publication
(10) Pub. No.: US 2015/0264623 A1
(43) Pub. Date: Sep. 17, 2015

(54) Data and Control Word Forwarding Using ORI Interface

(71) Applicant: VODAFONE IP LICENSING LIMITED, Newbury Berkshire (GB)

(72) Inventor: Timothy Frost, London (GB)

(21) Appl. No.: 14/438,804

(22) PCT Filed: Oct. 25, 2013
(86) PCT No.: PCT/EP2013/072436

§ 371 Date: Apr. 27, 2015

(30) Foreign Application Priority Data
Oct. 26, 2012 (GB) 1219292.8

(51) Int. Cl. H04W 40/00; H04L 12/721; H04L 12/741; H04W 72/04; H04L 29/06

(52) U.S. Cl. CPC H04W 40/00; H04W 72/0446; H04L 69/22; H04L 45/74; H04L 45/566

(57) ABSTRACT

A data or control word block received at an Open Radio equipment Interface (ORI) input port of a Radio Equipment (RE) can be forwarded. A transmission frame is configured for communication through an ORI output port of the RE, the transmission frame comprising the received block. The received block is identified within the transmission frame by: a size of the received block; and a start position of the received block within the transmission frame.

### TECHNICAL FIELD OF THE INVENTION

The invention concerns a method of forwarding a data or control word block received at an Open Radio equipment Interface (ORI) input port of a Radio Equipment (RE) and such an RE device.

### BACKGROUND TO THE INVENTION

The European Telecommunications Standards Institute (ETSI) Open Radio equipment Interface (ORI) standardisation group has defined an interface called ORI, especially for terminating two component nodes of a UMTS or LTE Base Station. The two component nodes are termed: the Radio Equipment Controller (REC) that performs the baseband processing functions (radio protocol Layer 1 and 2) of the Base Station and essentially corresponds with a Base Band Unit (BBU); and the Radio Equipment (RE) that performs the RF level functions (including transmission and reception of the radio signals over the air) and generally corresponds with a Remote Radio Head (RRH). The interface is an evolution of the Common Public Radio Interface (CPRI) specification and is generally built on that.

CPRI originally defined a framing structure for how bits are carried over a transmission link. These bits contain: IQ data (which is converted to RF in the downlink from BBU to RRH for radio interface transmission and vice versa on uplink when sent from RRH to BBU); and control words. The control words are then separated into bits to be used by higher layer Control and Management (C&M) and bits to be specified at a lower level for sending real time control data.

The Release 1 of the ORI specification was built on this framing structure and handled the scenario where each RE is directly connected to the REC. The C&M signalling layer has been defined that configures the RE for how to map IQ data bearers and how control word data (in real time) is used. However, the Release 2 specification considers more complex topologies where a second RE may only be connected physically to a first RE (in this case acting as a “networking” RE), such that the second RE sends and receives all of its traffic (air interface data, that is IQ data and ORI interface dynamic management signalling, that is control words) from the REC via the first RE. Hence, the first RE acts as a router between the REC and the second RE. Each link in the chain is known as a hop.

A number of such topologies are now presented as examples. Referring first to FIG. 1a, there is shown a first topology of a configuration of REC and RE using ORI links. A REC 10 is linked to a first RE 20 via a first ORI link 15. The first RE 20 is linked to a second RE30 by a second ORI link 25. The first ORI link 15 couples the master port 12 of the REC 10 to a slave port 21 of the first RE 20. The second ORI link 25 couples a master port 22 of the first RE 20 to a slave port 31 of a second RE 30.

This is termed a “chain” topology and allows the first RE 20 to relay the data between the REC 10 and second RE 30. This may be useful to reduce the number of links (such as optical fibres) needed between the REC 10 and a site (where a site may contain more than one RE). For example, the first RE 20 and second RE 30 may be co-located or located on separate sites, distant from the location of REC 10.

Referring next to FIG. 1b, there is shown a second topology. Where the same elements are shown as a previous drawing, identical reference numerals have been used. The REC 10 is coupled to a first RE 20 by a first ORI link 15. The first RE 20 is coupled to a second RE 30 by a second ORI link 25 and to a third RE 40 by a third ORI link 45. This is called a “tree” topology.

Referring next to FIG. 1c, there is shown a third topology. Again, the same elements as shown in previous drawings are referenced by identical numbering. The REC 10 is coupled to a first RE 20 by a first ORI link 15. The first RE 20 is coupled to a second RE 30 by a second ORI link 25. The second RE 30 is also coupled to the REC 10 by a third ORI link 35. This is termed a “ring” topology.

As part of these more sophisticated network topologies, each RE should be configured to forward both IQ data and control data from an REC to another RE (and vice versa) and from one RE to another RE. Referring next to FIG. 2, there is depicted a schematic illustration of the ORI protocol stack, showing IQ data and control words. This protocol stack may facilitate forwarding data in the IQ data area and the control words that are part of the ORI reserved area, CPRI reserved area, and vendor-specific control words or bits area.

Even with this protocol stack, each ORI link may be different, however, in terms of its physical configuration, bandwidth and structure. Moreover, Release 1 ORI only defines the structure of the Received Total Wideband Power (RTWP) measurement control words within the ORI reserved field and the structure of other control words is not known. Implementing this forwarding in an efficient way is therefore a challenge.

### SUMMARY OF THE INVENTION

Against this background, there is provided a method of forwarding a data or control word block received at an Open Radio equipment Interface (ORI) input port of a Radio Equipment (RE). The method comprises: identifying a location reference for the received data or control word block as part of a reception frame communicated through the ORI input port of the RE, the location reference comprising: a size of the received block; and a start position of the received block within the reception frame; and/or configuring a transmission frame for a communication through an ORI output port of the RE. The received block is mapped onto the transmission frame as a transmitted block. This by means of a location reference comprising: a size of the transmitted block; and a start position of the transmitted block within the transmission frame. A location reference can equivalently be termed a location index or similar.

The identification of the received block using a location reference comprising its size and start position within the reception frame allows the block to be delineated from other bits and thereby forwarded from an ORI input port to an ORI output port. Establishing a block as a set of consecutive bits and contiguous bits in this way may use an “object” model approach to configure the mapping of data received from one link that is to be forwarded to another. It may be understood that the mapping entity of the received block from the reception frame to the transmitted block of the transmitted frame is defined as a block object. This may allow forwarding in an efficient way. The use of a location reference for the transmitted block in the transmission frame may then be mapped from the location reference for the received block. A data block typically comprises IQ samples. In general, the forward and routing of data blocks and control word blocks is carried out in the same way, although differences are also possible.

Preferably, the location reference of the transmitted block within the transmission frame is based on the location reference of the received block within the reception frame. This may be used to configure the location reference for the transmitted block that is communicated via the transmission frame on the ORI output port using the location reference for the received block received in the reception frame. In most embodiments, the size of the transmitted block within the transmission frame is the same as the size of the reception block within the transmission frame. Indeed, the transmitted block preferably comprises identical data to the received block. In some embodiments, the location reference for the transmitted block within the transmission frame may be the same as the location reference of the received block within the reception frame. However, this is not necessarily so for all transmitted blocks. In any event, the RE receiving the data desirably has a consistent understanding of the location of the IQ data contents it will use to generate radio interface transmission. Otherwise, this can cause erroneous transmissions and possibly spurious emissions on the air interface.

In some embodiments, the ORI input port is in a first ORI input port. Then, the method may further comprise identifying a location reference for a second received block as part of a reception frame communicated through a second ORI input port of the RE, the location reference comprising: a size of the second received block; and a start position of the second received block within the reception frame. In this way, two blocks may be received via two separate ORI input ports of the RE. Moreover, they may be identified using individual location references. Advantageously, configuring the transmission frame for communication through the ORI output port comprises mapping the second received block onto the transmission frame as a second transmitted block by means of a location reference comprising: a size of the second transmitted block; and a start position of the second transmitted block within the transmission frame. Thus, the two blocks may be multiplexed onto the same transmission frame for forwarding to another RE or an REC via the ORI link at the ORI output port. Combining blocks at an RE may facilitate implementation of a tree topology, for example.

Other aspects to a tree topology may be considered. In some embodiments, the ORI output port is a first ORI output port and there may be a second ORI output port (distinct from the first). Then, the method may further comprise identifying a location reference for a second received block as part of a reception frame communicated through an ORI input port of the RE (which may be the first ORI input port or another ORI input port), the location reference comprising: a size of the second received block; and a start position of the second received block within the reception frame. Moreover, the method may further comprise configuring a transmission frame for communication through a second ORI output port of the RE. The second received block may be mapped onto the transmission frame as a transmitted block that is identified within the transmission frame by a location reference comprising: a size of the transmitted block; and a start position of the transmitted block within the transmission frame.

A signal path may correspond to the object that maps the data block (that is, IQ data) terminating (for RF transmission at the RE) or generating (received by the RE) the radio interface configuration. In other words, the signal path may be considered an object that terminates the IQ data for transmission or reception on the radio interface. It may be understood as mapping the radio interface configuration to an Antenna-Carrier combination (A×C) configuration, in a similar way that the data block object maps A×C data on one ORI link to another ORI link. For instance, the RE may generate signal path data, which may be for communication to an REC. Thus, the signal path data here is intended for onward communication through an ORI link, but is not forwarded data. In embodiments, the method may further comprise establishing signal path data generated at the RE for communication through the ORI output port as part of the transmission frame. Preferably, configuring the transmission frame for communication through the ORI output port comprises identifying the signal path data as block within the transmission frame by a location reference comprising: a size of the signal path data block; and a start position of the signal path data block within the transmission frame. Hence, the signal path data may be multiplexed with the forwarded block or blocks.

Advantageously, the location reference of the transmitted block and the location reference of the signal path data block are configured such that the signal path data block is overlaid on the transmitted block. In particular, this overlaying may be implemented in such a way that mitigates any conflicts between the transmitted block and the signal path data block. This may improve efficiency.

In some embodiments, data may be communicated from the REC and terminated at an RE as signal path data. In the latter case, this data may not be forwarded by the RE, especially if the location of the signal path data in the reception frame is not included within the received data block. It may be forwarded if the location of the A×C data is overlaid within in the received data block location, as discussed below. This terminating block (which may be IQ data and/or control word) may be multiplexed with a block or blocks for other REs. Embodiments may provide that the method further comprises identifying a location reference for a terminating block as part of the reception frame communicated through the ORI input port of the RE, the location reference comprising: a size of the terminating block; and a start position of the terminating data block within the reception frame. The terminating block is not forwarded and therefore is beneficially different from the received block that is mapped onto the transmission frame as the transmitted block.

However, the location reference for the terminating block can be efficiently used. For example, configuring the transmission frame may further comprise identifying a location reference for a new data block at the RE within the transmission frame. The location reference comprises: a size of the new block; and a start position of the new block within the transmission frame. Then, the location reference of the terminating block and the location reference of the new block may be configured such that the new block is overlaid on the terminating block. In particular, this overlaying may be implemented in such a way that mitigates conflicts between the blocks, especially the new block. The new block may be the transmitted block or another block. The new block may be a data (IQ data) block or it may be a control word block. The new block may be used for re-routing of data, for example, to offer redundancy in a ring topology.

The input ports and the output ports may have the same bandwidth (or link sizes). This may make it easier to translate between the location reference of a block received at an input port and the location reference of the block communicated via the output port. In other embodiments, the input ports and the output ports can have different respective bandwidths (or link sizes). Then, the size of the transmitted block and the start position of the transmitted block within the transmission frame may be configured according to the bandwidth of the output port. In this way, the location reference for the forwarded block may be configured according to the bandwidth of the ORI link at the output port.

The received block may be a data block, which may comprise IQ data bits. Additionally or alternatively, the received block may comprise data bits defined by a Common Public Radio Interface (CPRI), or CPRI standard. In this way, the CPRI-defined data bits may be included together with the block or form part of the data block. CPRI-defined data bits may include stuffing data bits or reserved data bits.

In the preferred embodiment, one of the input ports and the output ports is a master port and the other is a slave port. Typically, the master port of the RE will be the port that is communicating blocks away from the REC. However, this may not necessarily be the case, for example in a ring topology.

Also provided is a computer program, configured to perform the method as described herein when operated by a processor.

In a second aspect, the present invention provides a Radio Equipment (RE) device, comprising: an Open Radio equipment Interface (ORI) input port, configured to receive a data or control word block; and an ORI output port, configured to communicate a transmission frame comprising a transmitted block. The RE may further comprise: port control logic, configured to identify a location reference for the received block within the reception frame, the location reference comprising: a size of the received block; and the start position of the received block within the reception frame; and/or mapping logic, configured to map the received block onto the transmission frame as the transmitted block that is identified within the transmission frame by a location reference comprising: a size of the transmitted block; and a start position of the transmitted block within the transmission frame. The port control logic and the mapping logic may advantageously be combined.

It will be understood that the RE device of the second aspect may also comprise apparatus or structural features corresponding with the functional features defined with relation to the first aspect, described above. Also, any combination of features described herein is provided by the present invention, even if such a combination is not explicitly disclosed.

### BRIEF DESCRIPTION OF THE DRAWINGS

The invention may be put into practice in various ways, one of which will now be described by way of example only and with reference to the accompanying drawings in which:

FIGS. 1a, 1b and 1c show first, second and third topologies of a configuration of REC and RE using ORI links;

FIG. 2 depicts a schematic illustration of the ORI protocol stack, showing IQ data and control words;

FIG. 3 schematically illustrates examples of the forwarding of IQ blocks between REs and REC;

FIG. 4 provides a schematic illustration showing control word mapping to sub-channel allocation;

FIG. 5 schematically illustrates examples of the forwarding of control word blocks between REs and REC; and

FIGS. 6a and 6b illustrate an example control work frame structure.

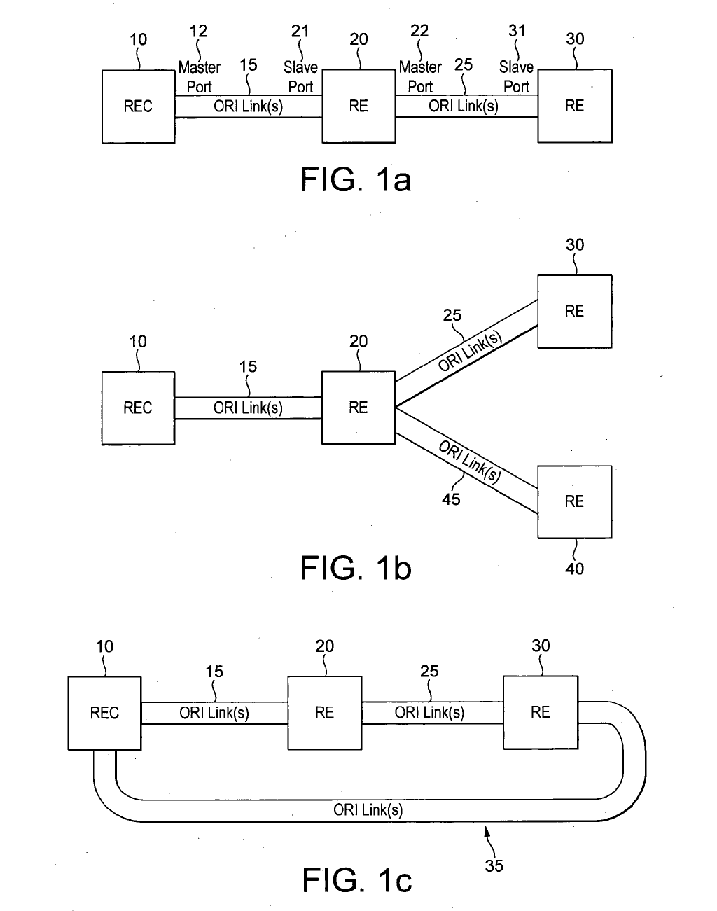

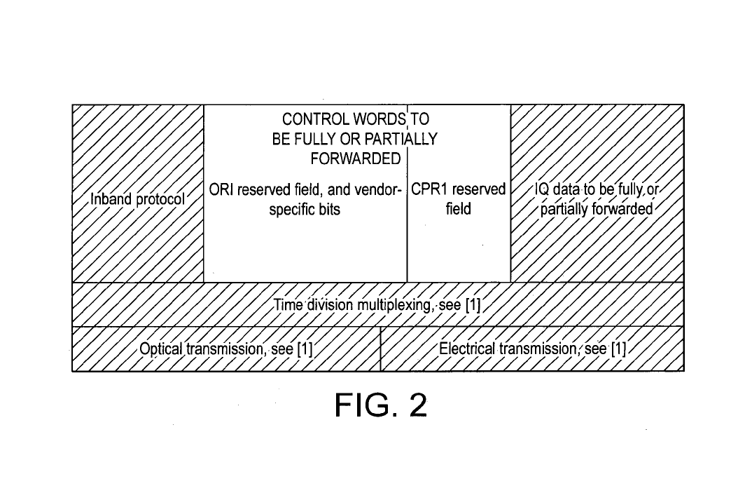

### DETAILED DESCRIPTION OF A PREFERRED EMBODIMENT

An IQ block is a set of consecutive bits within the IQ data area of the ORI protocol stack and contains data for one or more Antenna-Carrier combinations (A×Cs). This is normally data to be transmitted or received via a single antenna on a single UMTS or LTE carrier frequency.

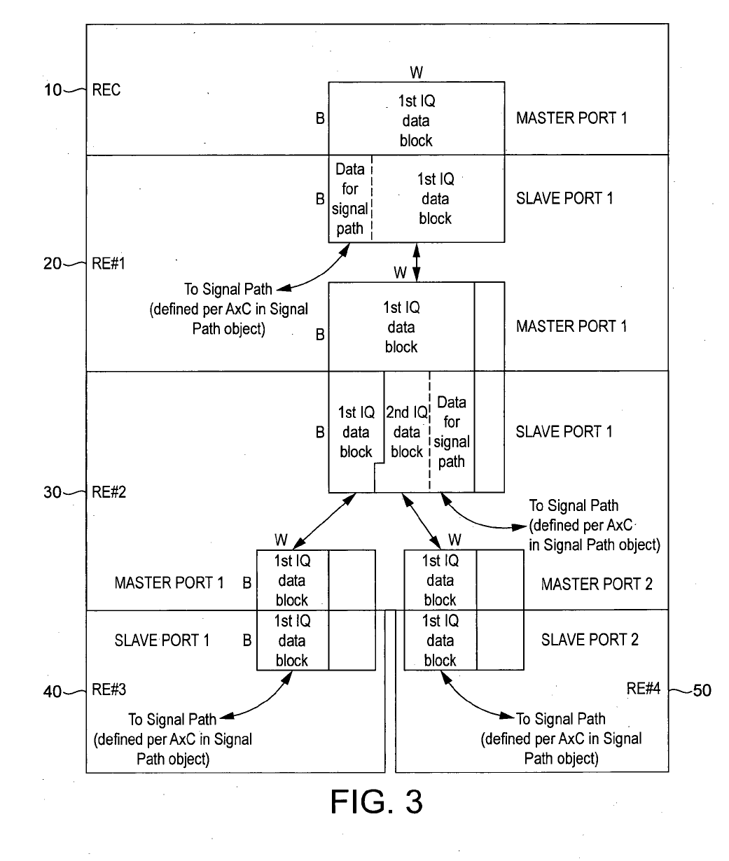

FIG. 3 schematically illustrates examples of the forwarding of IQ blocks between REs and the REC 10. The first RE 20 and second RE 30 are in a chain configuration, splitting into a tree configuration between the second RE 30, third RE 40 and fourth RE 50.

Where: the IQ data may change position between master and slave port within the same RE; the IQ data may route to a link where the bandwidth is not fully used up; or IQ data somewhere on the chain is mapped to a different location, then the location of the IQ data is desirably defined within the RE routing the data. Therefore, to allow for different topologies, the capability to configure the following is provided: IQ data block size to be received on slave and master ports; and start position of the IQ data block on master and slave ports. Thus, the RE identifies the IQ block using the block size and start position as a location reference for mapping onto an output port (which may be a master port or a slave port) and mapping between data received on an input port and data communicated via an output port.

When a Signal Path is terminated in a networking RE (for example the signal path shown terminating at the second RE 30), the upstream slave port can carry the A×C container data for this Signal Path overlaid onto an IQ data block that also carriers IQ data for other A×Cs, without impacting the block configuration. This may be provided as long as the bit positions of the IQ data block are not being used to carry other A×C container data.

In a similar manner, for re-routing of data, a new IQ data block may be created that is overlaid onto the IQ data of terminating Signal Paths, without affecting the transfer of data across the ORI link for those Signal Paths. Again, this may be provided while ensuring conflicts with A×C container within the block are avoided. Re-routing of data may be provided, for example, to offer redundancy in a ring topology.

Forwarding of CPRI-defined stuffing or reserved data bits is desirably further provided. These may be forwarded using the same IQ block forwarding mechanism and could be included within the same IQ block as any IQ data bits following the same route.

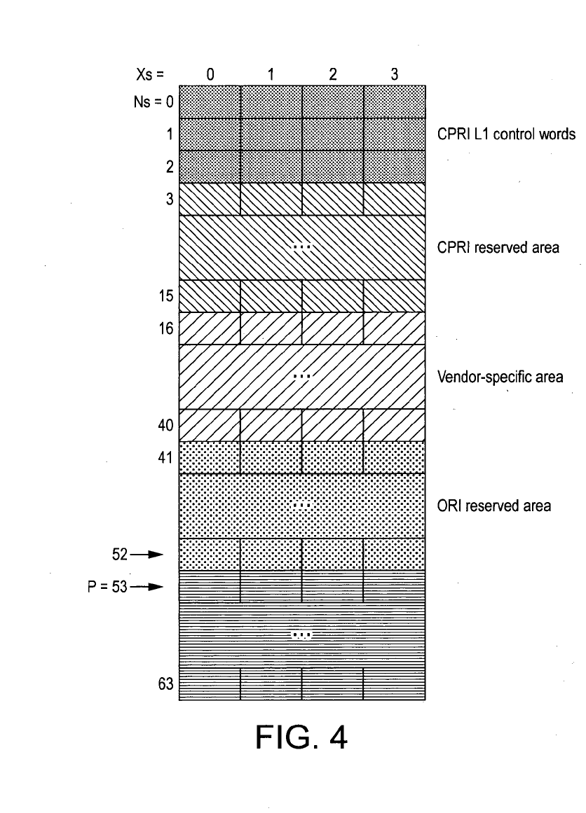

Control word forwarding is also provided, alongside IQ data forwarding. There are different types of control word that may, depending on the use case, also be forwarded between master and slave ports of a RE. Referring next to FIG. 4, there is provided a schematic illustration showing control word mapping to sub-channel allocation. This shows the control word types specified within the ETSI ORI standard specifications. Vendor-specific, CPRI reserved, and ORI reserved control words are all desirably forwarded. A generic mechanism to configure control word forwarding within the networking RE is therefore advantageous. The alternative would be to provide a specific solution for forwarding control words (where the use case demands it), which is not desirable. Nonetheless, control word forwarding solutions for specified control words (in particular, RTWP and CTRL A×Cs) in ORI may be desirable in some cases. For convenience, a table is included below to show what a RTWP measurement control word block routing object may look like.

Generic forwarding of control word blocks in control word frame structure may be provided in the following way. In terms of the flexibility required for the indexing of control words, it is sensible to consider existing use cases defined within both ORI and CPRI specifications.

1. In CPRI the granularity only goes down the control word level and it does not seem to be very beneficial to split information for a single context into consecutive blocks smaller than 1 byte.

2. Both the RTWP control words and the Ctrl A×Cs split data for the same information context across two sub-channels, but not across different values of Xs.

3. The RTWP control words only use certain hyper-frames (HFNs), allowing the possibility to reuse the non-used HFNs for other purposes.

Control word blocks can therefore be defined, which may contain one or more control words that are consecutively located within the control word frame structure. The control word block is effectively equivalent to an IQ block as discussed above.

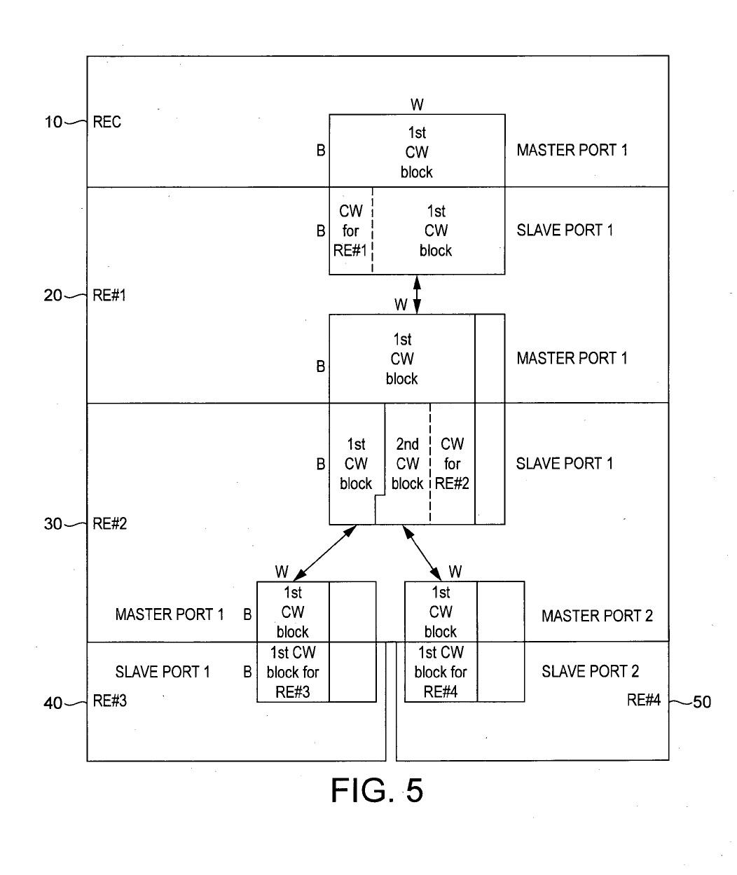

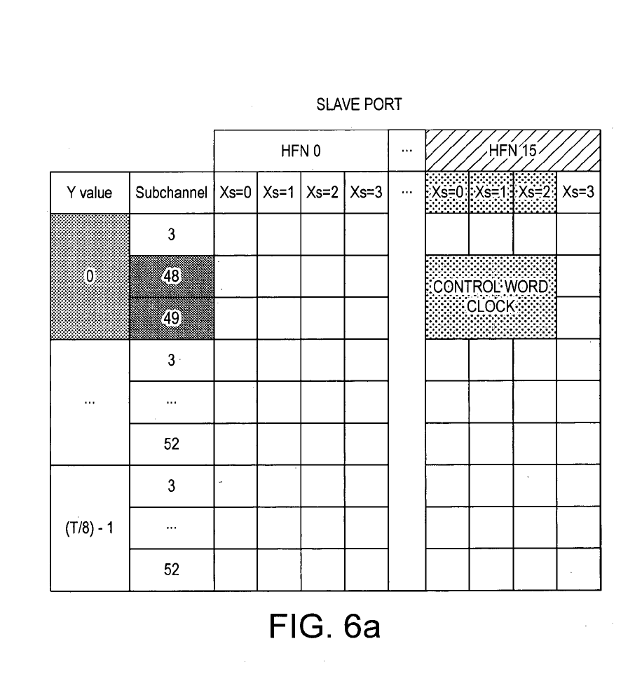

Referring now to FIG. 5, there is schematically illustrated examples of the forwarding of control word blocks between REs and REC. The configuration of FIG. 5 is the same as that of FIG. 3 and the result is very similar to the IQ data block forwarding concept described with reference to the earlier drawing.

In order for the REC 10 to configure the block forwarding in the networking RE, the solution provides both “block size information” in each domain of the frame structure for each ORI link (slave and master port), as well as the “block start position” of the data in the frame structure on each ORI link.

Block size information would be: a number of consecutive sub-channels (per slave/master port); a number of consecutive Xs values (per slave/master port); a number of consecutive Y values (per slave/master port); a HFN value restrictions for control word mapping=“ALL”, or “list of HFN #Z”; and optionally control word type: “CPRI reserved field”, “Vendor specific field”, and “ORI reserved field” (maybe defined as the object type).

For indicating the block start position, the following parameters are used: Y values start position (per slave/master port, given that Y values change with link size); sub-channel start position (optionally if per slave/master port); and Xs values start position (optionally if per slave/master port).

In the same way as for the IQ data, if part of the data in the received blocks is to be terminated by the receiving RE, then the forwarded data may be a smaller size than the received control word block. In this case, the rest of the control word block is passed on to the target port starting at the start position indicated for the target port. Hence the block size to be forwarded may be different on slave and master ports.

Taking this into account, it is desirable to avoid overbooking or reconfiguration of the upstream control word block to avoid overlap with a newly created object terminating the control word in the networking RE. Then, the corresponding size of the block on both ports may be configured. In the uplink, overbooking is unlikely to happen, so the block size information may only be needed on the master port side.

Values from the table below (showing Control word block routing configuration parameters) may provide the frame structure index of a control word.

| Parameter | Value |
|---|---|
| Sub-channel start position slave port | 48 |
| Sub-channel start position master port | 46 |
| Number of consecutive sub-channels in slave port | 2 |
| block | |
| Number of consecutive sub-channels in master port | 2 |
| block | |
| Xs value start position slave port | 0 |
| Xs value start position master port | 1 |
| Number of consecutive Xs values in slave port block | 3 |
| Number of consecutive Xs values in master port | 3 |
| block | |
| Y value start position slave port | 0 |
| Y value start position master port | 2 |
| Number of consecutive Y values in slave port block | 1 |
| Number of consecutive Y values in master port block | 1 |
| HFN value restriction list size | 1 |
| HFN value restriction, 1^{st} HFN | 15 |

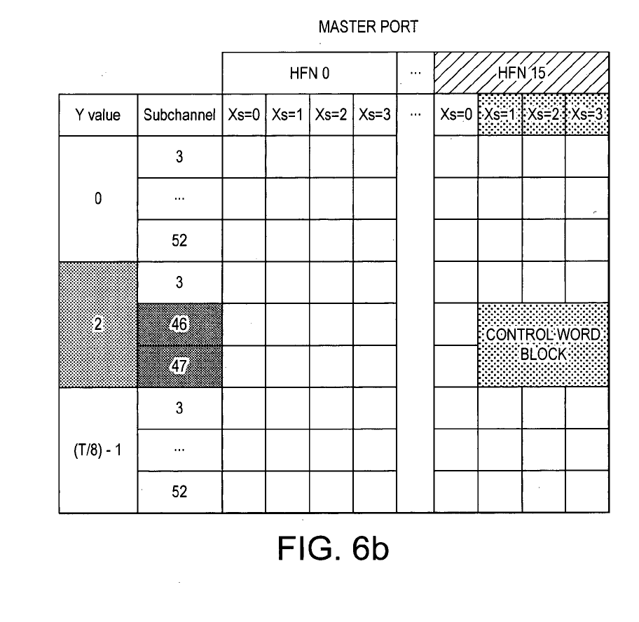

Referring now to FIGS. 6a and 6b, there is illustrated an example control word frame structure, which is based on this information. The portions marked “CONTROL WORD BLOCK” indicate the placement of the consecutive data on each port. In some embodiments, Y domain may allow a different start position on mapped master and slave ports. However, in other embodiments also the sub-channel and Xs domains may allow a different start position on mapped master and slave ports.

Object principles and definitions are now presented. The principles are as follows.

1. Due to the lack of a one-to-one mapping between IQ data and control words, independent objects for control word blocks and IQ data are used. In cases where a restriction in the mapping is agreed (for example, the RTWP measurement control word shall be mapped onto the same ORI Link as the IQ data for the corresponding A×C RTWP groups carried), this can be defined explicitly.

2. IQ data blocks follow the rules regarding Administrative (AST) and Functional (FST) states (discussed below), to cope with topology reconfigurations.

3. Control word blocks also follow the same AS and FST state principles to cope with topology reconfigurations.

4. Parent slave-master port mapping object parenting “IQ data block” and “Control word block” child objects may be provided.

Objects may be assigned states, including AST and FST states, as noted above. AST is normally controlled by the REC. It may be used as a way to manage the object. FST typically autonomously occurs within the RE (although there is a relation between AST state and FST state, for example typically FST=“not operational” when AST=“Locked”). The states are defined in ETSI GS ORI 002-2 v.2.1.1 in section 6.7.

The following object types are used for routing of IQ data blocks. Reference to the CPRI specification below indicates the CPRI v5.0 specification.

### Downlink IQ Block Routing Object

### Object Description:

The Downlink IQ Block Routing object represents the entity that routes a block of bits contiguously-located in the IQ data area of each basic frame terminating at the slave port to the IQ data area of a corresponding basic frame on the master port.

### Permitted States:

### AST:

In state LOCKED: The IQ block routing instance is available for configuration. I/Q data transfer via this routing instance is stopped.
In state UNLOCKED: The IQ block routing instance is not available for configuration I/Q data transfer via this routing instance is enabled.
Transition from UNLOCKED to LOCKED: Preconditions (in addition to default parent/child rules): None.
Actions: I/Q data transfer via this routing instance shall be stopped.
Transition from LOCKED to UNLOCKED: Preconditions (in addition to default parent/child rules): Unlocking shall be denied with the failure codes listed below under the following conditions:
FAIL_PRECONDITION_NOTMET if the parent ORI link is not in FST state Operational at the time of the request.
FAIL_PRECONDITION_NOTMET if the referenced master ORI link is not in FST state Operational at the time of the request, or if the “Port Role” parameter of the referenced slave ORI link is not set to SLAVE. FAIL_RESOURCE_UNAVAILABLE if the configured parameters do not lead to a valid configuration. This can be either because the value of B exceeds the valid range determined by the line bit rate, or because the values of W,B and IQ block size lead to overlap with already allocated IQ blocks (on slave port or master port side).
Actions: I/Q data transfer via this routing instance is enabled. AST initial state is LOCKED when the object is created.

### FST: None.

### Object Lifecycle:

Dynamic. One instance per IQ block that needs to be routed.

### Containment:

Object contained in ORI Link object (able to operate only when ORI link has port role set to MASTER).

### Encoded Name:

“downlinkIQBlockRouting”

### Parameters:

According to the following Downlink IQ Block Routing Object Parameters table.

| | | | |
|---|---|---|---|
| Parameter | Description | Type | Range |

| | |
|---|---|
| IQ data | The number of bits |
| block size | contained in the IQ |
| (master | data block sent by |
| port) | the RE on the master |
| | port. |
| Master | The parameter W used |
| port IQ | together with |
| data block | parameter B defines |
| start | the position of the |
| position | first bit of the IQ |
| parameter | data block within the |
| (W) | Basic Frame on the |
| | link of the master |
| | port. Parameter W is |
| | defined in CPRI |
| | specification. |
| | Management type: R/W- |
| | Locked |
| Master | The parameter B used |
| port IQ | together with |
| data block | parameter W defines |
| start | the position of the |
| position | first bit of the IQ |
| parameter | data block within the |
| (B) | Basic Frame on the |
| | link of the master |
| | port. Parameter B is |
| | defined in CPRI |
| | specification. |
| | Management type: R/W- |
| | Locked |
| Slave port | Reference to the |
| ORI Link | slave port ORI link |
| | to which the IQ block |
| | routing instance is |
| | mapped. |
| | The ORI Link being |
| | referenced must be in |
| | slave mode when this |
| | IQ block routing |
| | instance is unlocked. |
| | Management type: R/W- |
| | Locked |
| IQ data | The number of bits |
| block size | contained in the IQ |
| (slave | data block received |
| port) | by the RE on the |
| | slave port. |
| Slave port | The parameter W used |
| IQ data | together with |
| block | parameter B defines |
| start | the position of the |
| position | first bit of the IQ |
| parameter | data block within the |
| (W) | Basic Frame on the |
| | link of the slave |
| | port. Parameter W is |
| | defined in CPRI |
| | specification. |
| | Management type: R/W- |
| | Locked |
| Slave port | The parameter B used |
| IQ data | together with |
| block | parameter W defines |
| start | the position of the |
| position | first bit of the IQ |
| parameter | data block within the |
| (B) | Basic Frame on the |
| | link of the slave |
| | port. Parameter B is |
| | defined in CPRI |
| | specification. |
| | Management type: R/W- |
| | Locked |
| Tbdelay DL | The delay of the |
| | downlink signal |
| | between slave port |
| | and master port |
| | connected by this |
| | routing instance in |
| | networking RE. See |
| | CPRI Specification |
| | for further |
| | definition. |

### Uplink IQ Block Routing Object

### Object Description:

The Uplink IQ Block Routing object represents the entity that routes a block of bits contiguously-located in the IQ data area of each basic frame terminating at the master port to the IQ data area of a corresponding basic frame on the slave port.

### Permitted States:

### AST:

In state LOCKED: IQ block routing instance is available for configuration. I/Q data transfer via this routing instance is stopped.
In state UNLOCKED: The IQ block routing instance is not available for configuration. I/Q data transfer via this routing instance is enabled.
Transition from UNLOCKED to LOCKED:
Preconditions (in addition to default parent/child rules): None.
Actions: I/Q data transfer via this routing instance is stopped.
Transition from LOCKED to UNLOCKED:
Preconditions (in addition to default parent/child rules): Unlocking shall be denied with the failure codes listed below under the following conditions: FAIL_PRECONDITION_NOTMET if the parent ORI link is not in FST state Operational at the time of the request.
FAIL_PRECONDITION_NOTMET if the referenced slave ORI link is not in FST state Operational at the time of the request, or if the “Port Role” parameter of the referenced slave ORI link is not set to SLAVE. FAIL_RESOURCE_UNAVAILABLE if the configured parameters do not lead to a valid configuration.
This can be either because the value of B exceeds the valid range determined by the line bit rate, or because the values of W,B and IQ block size lead to overlap with already allocated IQ blocks (on slave port or master port side).
Actions: I/Q data transfer via this routing instance is enabled. AST initial state is LOCKED when the object is created. FST: None.

### Object Lifecycle:

Dynamic. One instance per UL IQ block that needs to be routed.

### Containment:

Object contained in ORI Link object (able to operate only when ORI link has port role set to MASTER).

### Encoded Name:

“uplinkIQBlockRouting”

### Parameters:

According to the following UL IQ Block Routing Object Parameters table.

| | | | |
|---|---|---|---|
| Parameter | Description | Type | Range |

| | | |
|---|---|---|
| IQ data | The number of bits | |
| block size | contained in the IQ | |
| (master | data block received | |
| port) | by the RE on the | |
| | master port. | |
| Master | The parameter W used | |
| port IQ | together with | |
| data block | parameter B defines | |
| start | the position of the | |
| position | first bit of the IQ | |
| parameter | data block within the | |
| (W) | Basic Frame on the | |
| | link of the master | |
| | port. Parameter W is | |
| | defined in CPRI | |
| | specification. | |
| | Management type: R/W- | |
| | Locked | |
| Master | The parameter B used | |
| port IQ | together with | |
| data block | parameter W defines | |
| start | the position of the | |
| position | first bit of the IQ | |
| parameter | data block within the | |
| (B) | Basic Frame on the | |
| | link of the master | |
| | port. Parameter B is | |
| | defined in CPRI | |
| | specification. | |
| | Management type: R/W- | |
| | Locked | |
| Slave port | Reference to the | |
| ORI Link | slave port ORI link | |
| | to which the IQ block | |
| | routing instance is | |
| | mapped. | |
| | The ORI Link being | |
| | referenced shall be | |
| | in slave mode when | |
| | this IQ block routing | |
| | instance is unlocked. | |
| | Management type: R/W- | |
| | Locked | |
| IQ data | The number of bits | |
| block size | contained in the IQ | |
| (slave | data block sent by | |
| port) | the RE on the slave | |
| | port. | |
| Slave port | The parameter W used | |
| IQ data | together with | |
| block | parameter B defines | |
| start | the position of the | |
| position | first bit of the IQ | |
| parameter | data block within the | |
| (W) | Basic Frame on the | |
| | link of the slave | |
| | port. Parameter W is | |
| | defined in CPRI | |
| | specification. | |
| | Management type: R/W- | |
| | Locked | |
| Slave port | The parameter B used | |
| IQ data | together with | |
| block | parameter W defines | |
| start | the position of the | |
| position | first bit of the IQ | |
| parameter | data block within the | |
| (B) | Basic Frame on the | |
| | link of the slave | |
| | port. Parameter B is | |
| | defined in CPRI | |
| | specification. | |
| | Management type: R/W- | |
| | Locked | |
| Tbdelay UL | The delay of the | |
| | uplink signal between | |
| | master port and slave | |
| | port connected by | |
| | this routing instance | |
| | in networking RE. See | |
| | CPRI Specification | |
| | for further | |
| | definition. | |
| N | Provided by | 0 . . . TBD |
| | networking RE to be | Units: |
| | used for uplink frame | Basic |
| | timing calculation in | frames |
| | multi-hop | |
| | configuration. See | |
| | section 4.2.9.2 in | |
| | CPRI Specification | |
| | for further | |
| | definition. | |

The following new object types are proposed for routing of control word blocks. If desirable, each generic control word type may be split into object types specific to each type of control word (vendor-specific, CPRI reserved, ORI reserved). The range of sub-channels could then be modified for each control word type.

### Uplink Control Word Block Routing Object

### Object Description:

The Uplink Control Word Block Routing object represents the entity that routes a block of bits contiguously-located in the control word area of the ORI link terminating at the master port to the control word area of the ORI link on the slave port.

### Permitted States:

### AST:

### In State LOCKED:

Control word block routing instance is available for configuration. Control word transfer via this routing instance is stopped.
In state UNLOCKED:
The control word block routing instance is not available for configuration. Control word transfer via this routing instance is enabled.
Transition from UNLOCKED to LOCKED:
Preconditions (in addition to default parent/child rules: None.
Actions: Control word transfer via this routing instance is stopped.
Transition from LOCKED to UNLOCKED:
Preconditions (in addition to default parent/child rules): Unlocking shall be denied with the failure codes listed below under the following conditions: FAIL_PRECONDITION_NOTMET if the parent ORI link is not in FST state Operational at the time of the request. FAIL_PRECONDITION_NOTMET if the referenced slave ORI link is not in FST state Operational at the time of the request, or if the “Port Role” parameter of the referenced slave ORI link is not set to SLAVE.
FAIL_RESOURCE_UNAVAILABLE if the configured parameters do not lead to a valid configuration. This can be either because the value of B exceeds the valid range determined by the line bit rate, or because the values of W,B and IQ block size lead to overlap with already allocated IQ blocks (on slave port or master port side).
Actions: Control word transfer via this routing instance is enabled. AST initial state is LOCKED when the object is created. FST: None.

### Object Lifecycle:

Dynamic. One instance per control word block that needs to be routed.

### Containment:

Object contained in ORI Link object (able to operate only when ORI link has port role set to MASTER).

### Encoded Name:

“ulCWBlockRouting”

### Parameters

According to the following Uplink Control Word Block Routing object table.

| | | | |
|---|---|---|---|
| Parameter | Description | Type | Range |

| | | |
|---|---|---|
| Sub- | The first sub-channel | |
| channel | of the control word | |
| start | block within the | |
| position | Basic Frame on the | |
| master | link of the master | |
| port | port. | |
| | Management type: R/W- | |
| | Locked | |
| [Sub- | The first sub-channel | |
| channel | of the control word | |
| start | block within the | |
| position | Basic Frame on the | |
| slave | link of the slave | |
| port] | port. | |
| | Management type: R/W- | |
| | Locked | |
| Number of | The number of | |
| consecutive | consecutive sub- | |
| sub- | channels contained in | |
| channels | the control word | |
| in master | block received by the | |
| port block | RE on the master | |
| | port. | |
| | Management type: R/W- | |
| | Locked | |
| [Number of | The number of | |
| consecutive | consecutive sub- | |
| sub- | channels contained in | |
| channels | the control word | |
| in slave | block sent by the RE | |
| port | on the slave port. | |
| block] | Management type: R/W- | |
| | Locked | |
| Xs value | The first Xs location | |
| start | of the sub-channel of | |
| position | the control word | |
| master | block within the | |
| port | Basic Frame on the | |
| | link of the master | |
| | port. | |
| | Management type: R/W- | |
| | Locked | |
| [Xs value | The first Xs location | |
| start | of the sub-channel of | |
| position | the control word | |
| slave | block within the | |
| port] | Basic Frame on the | |
| | link of the slave | |
| | port. | |
| | Management type: R/W- | |
| | Locked | |
| Number of | The number of | |
| consecutive | consecutive Xs | |
| Xs | locations of the sub- | |
| values in | channel contained in | |
| master | the control word | |
| port block | block received by the | |
| | RE on the master | |
| | port. | |
| | Management type: R/W- | |
| | Locked | |
| [Number of | The number of | |
| consecutive | consecutive Xs | |
| Xs | locations of the sub- | |
| values in | channel contained in | |
| slave port | the control word | |
| block] | block sent by the RE | |
| | on the slave port. | |
| | Management type: R/W- | |
| | Locked | |
| Y value | The first Y location | |
| start | of the sub-channel of | |
| position | the control word | |
| slave port | block within the | |
| | Basic Frame on the | |
| | link of the master | |
| | port. | |
| | Management type: R/W- | |
| | Locked | |
| Y value | The first Y location | |
| start | of the sub-channel of | |
| position | the control word | |
| master | block within the | |
| port | Basic Frame on the | |
| | link of the slave | |
| | port. | |
| | Management type: R/W- | |
| | Locked | |
| Number of | The number of | |
| consecutive | consecutive Y | |
| Y values | locations of the sub- | |
| in master | channel contained in | |
| port block | the control word | |
| | block received by the | |
| | RE on the master | |
| | port. | |
| | Management type: R/W- | |
| | Locked | |
| [Number of | The number of | |
| consecutive | consecutive Y | |
| Y values | locations of the sub- | |
| in slave | channel contained in | |
| port | the control word | |
| block] | block sent by the RE | |
| | on the slave port. | |
| | Management type: R/W- | |
| | Locked | |
| HFN value | List of HFN values | 0 . . . maxHFN |
| restriction | that are allowed to | Value 0 = |
| list | carry this control | no |
| size | word block. | restriction |
| | Management type: R/W- | |
| | Locked | |
| HFN value | HFN value | |
| restriction, | Management type: R/W- | |
| 1^{st} HFN | Locked | |
| HFN value | HFN value | |
| restriction, | Management type: R/W- | |
| Z^{th} HFN | Locked | |
| Slave Port | Reference to the | |
| ORI Link | slave port ORI link | |
| | to which the control | |
| | word block routing | |
| | instance is mapped. | |
| | The ORI Link being | |
| | referenced shall be | |
| | in slave mode when | |
| | this control word | |
| | block routing | |
| | instance is unlocked. | |
| | Management type: R/W- | |
| | Locked | |

### Optional RTWP Measurement Control Word Block Routing Object

### Object Description:

The RTWP Measurement Control Word Block Routing object represents the entity that routes a block of bits contiguously-located in the control word area of the ORI link terminating at the master port to the control word area of the ORI link on the slave port.

### Permitted States:

### AST:

In state LOCKED: Control word block routing instance is available for configuration. Control word transfer via this routing instance is stopped.
In state UNLOCKED: The control word block routing instance is not available for configuration. Control word transfer via this routing instance is enabled.
Transition from UNLOCKED to LOCKED:
Preconditions (in addition to default parent/child rules): None.
Actions: Control word transfer via this routing instance is stopped.
Transition from LOCKED to UNLOCKED:
Preconditions (in addition to default parent/child rules): Unlocking shall be denied with the failure codes listed below under the following conditions: FAIL_PRECONDITION_NOTMET if the parent ORI link is not in FST state Operational at the time of the request. FAIL_PRECONDITION_NOTMET if the referenced slave ORI link is not in FST state Operational at the time of the request, or if the “Port Role” parameter of the referenced slave ORI link is not set to SLAVE.
FAIL_RESOURCE_UNAVAILABLE if the configured parameters do not lead to a valid configuration.
This can be either because the value of B exceeds the valid range determined by the line bit rate, or because the values of W,B and IQ block size lead to overlap with already allocated IQ blocks (on slave port or master port side).
Actions: Control word transfer via this routing instance is enabled. AST initial state is LOCKED when the object is created. FST: None.

### Object Lifecycle:

Dynamic. One instance per control word block that needs to be routed.

### Containment:

Object contained in ORI Link object (able to operate only when ORI link has port role set to MASTER).

### Encoded Name:

“ulRTWPBlockRouting”

### Parameters

According to the following Uplink RTWP Measurement Control Word Block Routing object table.

| | | | |
|---|---|---|---|
| Parameter | Description | Type | Range |

| | |
|---|---|
| [AxC RTWP | The first AxC RTWP |
| Group | Group of the control |
| start | word block within the |
| position | Basic Frame on the |
| slave | link of the slave |
| port] | port. |
| | Management type: R/W- |
| | Locked |
| AxC RTWP | The first AxC RTWP |
| Group | Group of the control |
| start | word block within the |
| position | Basic Frame on the |
| master | link of the master |
| port | port. |
| | Management type: R/W- |
| | Locked |
| Number of | The number of |
| consecutive | consecutive AxC RTWP |
| AxC RTWP | Groups contained in |
| Groups in | the control word |
| master | block received by the |
| port block | RE on the master |
| | port. |
| | Management type: R/W- |
| | Locked |
| [Number of | The number of |
| consecutive | consecutive AxC RTWP |
| AxC RTWP | Groups contained in |
| Groups in | the control word |
| slave port | block sent by the RE |
| block] | on the slave port. |
| | Management type: R/W- |
| | Locked |
| Slave Port | Reference to the |
| ORI Link | slave port ORI link |
| | to which the control |
| | word block routing |
| | instance is mapped. |
| | The ORI Link being |
| | referenced shall be |
| | in slave mode when |
| | this control word |
| | block routing |
| | instance is unlocked. |
| | Management type: R/W- |
| | Locked |

### DOWNLINK Control Word Block Routing Object

### Object Description:

The Downlink Control Word Block Routing object represents the entity that routes a block of bits contiguously-located in the control word area of the ORI link terminating at the slave port to the control word area of the ORI link on the master port.

### Permitted States:

### AST:

In state LOCKED: Control word block routing instance is available for configuration. Control word transfer via this routing instance is stopped.
In state UNLOCKED: The control word block routing instance is not available for configuration. Control word transfer via this routing instance is enabled.
Transition from UNLOCKED to LOCKED:
Preconditions (in addition to default parent/child rules): None.
Actions: Control word transfer via this routing instance is stopped.
Transition from LOCKED to UNLOCKED:
Preconditions (in addition to default parent/child rules): Unlocking shall be denied with the failure codes listed below under the following conditions: FAIL_PRECONDITION_NOTMET if the parent ORI link is not in FST state Operational at the time of the request. FAIL_PRECONDITION_NOTMET if the referenced slave ORI link is not in FST state Operational at the time of the request, or if the “Port Role” parameter of the referenced slave ORI link is not set to SLAVE.
FAIL_RESOURCE_UNAVAILABLE if the configured parameters do not lead to a valid configuration. This can be either because the value of B exceeds the valid range determined by the line bit rate, or because the values of W,B and IQ block size lead to overlap with already allocated IQ blocks (on slave port or master port side).
Actions: Control word transfer via this routing instance is enabled. AST initial state is LOCKED when the object is created. FST: None.

### Object Lifecycle:

Dynamic. One instance per control word block that needs to be routed.

### Containment:

Object contained in ORI Link object (able to operate only when ORI link has port role set to MASTER).

### Encoded Name:

“dlCWBlockRouting”

### Parameters

According to the following Downlink Control Word Block Routing object table.

| | | | |
|---|---|---|---|
| Parameter | Description | Type | Range |

| | | |
|---|---|---|
| Sub- | The first sub-channel | |
| channel | of the control word | |
| start | block within the | |
| position | Basic Frame on the | |
| master | link of the master | |
| port | port. | |
| | Management type: R/W- | |
| | Locked | |
| [Sub- | The first sub-channel | |
| channel | of the control word | |
| start | block within the | |
| position | Basic Frame on the | |
| slave | link of the slave | |
| port] | port. | |
| | Management type: R/W- | |
| | Locked | |
| Number of | The number of | |
| consecutive | consecutive sub- | |
| sub- | channels contained in | |
| channels | the control word | |
| in master | block sent by the RE | |
| port block | on the master port. | |
| | Management type: R/W- | |
| | Locked | |
| [Number of | The number of | |
| consecutive | consecutive sub- | |
| sub- | channels contained in | |
| channels | the control word | |
| in slave | block received by the | |
| port | RE on the slave port. | |
| block] | Management type: R/W- | |
| | Locked | |
| Xs value | The first Xs location | |
| start | of the sub-channel of | |
| position | the control word | |
| master | block within the | |
| port | Basic Frame on the | |
| | link of the master | |
| | port. | |
| | Management type: R/W- | |
| | Locked | |
| [Xs value | The first Xs location | |
| start | of the sub-channel of | |
| position | the control word | |
| slave | block within the | |
| port] | Basic Frame on the | |
| | link of the slave | |
| | port. | |
| | Management type: R/W- | |
| | Locked | |
| Number of | The number of | |
| consecutive | consecutive Xs | |
| Xs | locations of the sub- | |
| values in | channel contained in | |
| master | the control word | |
| port block | block sent by the RE | |
| | on the master port. | |
| | Management type: R/W- | |
| | Locked | |
| [Number of | The number of | |
| consecutive | consecutive Xs | |
| Xs | locations of the sub- | |
| values in | channel contained in | |
| slave port | the control word | |
| block] | block received by the | |
| | RE on the slave port. | |
| | Management type: R/W- | |
| | Locked | |
| Y value | The first Y location | |
| start | of the sub-channel of | |
| position | the control word | |
| slave port | block within the | |
| | Basic Frame on the | |
| | link of the master | |
| | port. | |
| | Management type: R/W- | |
| | Locked | |
| Y value | The first Y location | |
| start | of the sub-channel of | |
| position | the control word | |
| master | block within the | |
| port | Basic Frame on the | |
| | link of the slave | |
| | port. | |
| | Management type: R/W- | |
| | Locked | |
| Number of | The number of | |
| consecutive | consecutive Y | |
| Y values | locations of the sub- | |
| in master | channel contained in | |
| port block | the control word | |
| | block sent by the RE | |
| | on the master port. | |
| | Management type: R/W- | |
| | Locked | |
| [Number of | The number of | |
| consecutive | consecutive Y | |
| Y values | locations of the sub- | |
| in slave | channel contained in | |
| port | the control word | |
| block] | block received by the | |
| | RE on the slave port. | |
| | Management type: R/W- | |
| | Locked | |
| HFN value | List of HFN values | 0 . . . maxHFN |
| restriction | that are allowed to | Value 0 = |
| list | carry this control | no |
| size | word block. | restriction |
| | Management type: R/W- | |
| | Locked | |
| HFN value | HFN value | |
| restriction, | Management type: R/W- | |
| 1^{st} HFN | Locked | |
| HFN value | HFN value | |
| restriction, | Management type: R/W- | |
| Z^{th} HFN | Locked | |
| Slave Port | Reference to the | |
| ORI Link | slave port ORI link | |
| | to which the control | |
| | word block routing | |
| | instance is mapped. | |
| | The ORI Link being | |
| | referenced shall be | |
| | in slave mode when | |
| | this control word | |
| | block routing | |
| | instance is unlocked. | |
| | Management type: R/W- | |
| | Locked | |

1. A method of forwarding a data or control word block received at an Open Radio equipment Interface, ORI, input port of a Radio Equipment, RE, the method comprising:
identifying a location reference for the received data or control word block as part of a reception frame communicated through the ORI input port of the RE, the location reference comprising: a size of the received block; and a start position of the received block within the reception frame; and
configuring a transmission frame for communication through an ORI output port of the RE, the received block being mapped onto the transmission frame as a transmitted block that is identified within the transmission frame by a location reference comprising: a size of the transmitted block; and a start position of the transmitted block within the transmission frame.

2. The method of claim 1, wherein the location reference of the transmitted block within the transmission frame is based on the location reference of the received block within the reception frame.

3. The method of claim 2, wherein the size of the transmitted block within the transmission frame is the same as the size of the reception block within the reception frame.

4. The method of claim 1, wherein the ORI input port is a first ORI input port, the method further comprising:
identifying a location reference for a second received block as part of a reception frame communicated through a second ORI input port of the RE, the location reference comprising: a size of the second received block; and a start position of the second received block within the reception frame; and
wherein configuring the transmission frame for communication through the ORI output port comprises mapping the second received block onto the transmission frame as a second transmitted block by means of a location reference comprising: a size of the second transmitted block; and a start position of the second transmitted block within the transmission frame.

5. The method of claim 1, wherein the ORI output port is a first ORI output port, the method further comprising:
identifying a location reference for a second received block as part of a reception frame communicated through an ORI input port of the RE, the location reference comprising: a size of the second received block; and a start position of the second received block within the reception frame; and
configuring a transmission frame for communication through a second ORI output port of the RE, the second received block being mapped onto the transmission frame as a transmitted block that is identified within the transmission frame by a location reference comprising: a size of the transmitted block; and a start position of the transmitted block within the transmission frame.

6. The method claim 1, further comprising:
establishing signal path data generated at the RE for communication through the ORI output port as part of the transmission frame; and
wherein configuring the transmission frame for communication through the ORI output port comprises identifying the signal path data as a block within the transmission frame by a location reference comprising: a size of the signal path data block; and a start position of the signal path data block within the transmission frame.

7. The method of claim 6, wherein the location reference of the transmitted block and the location reference of the signal path data block are configured such that the signal path data block is overlaid on the transmitted block.

8. The method of claim 1, further comprising:
identifying a location reference for a terminating block as part of the reception frame communicated through the ORI input port of the RE, the location reference comprising: a size of the terminating block; and a start position of the terminating block within the reception frame.

9. The method of claim 8, wherein configuring the transmission frame further comprises identifying a location reference for a new block at the RE within the transmission frame, the location reference comprising: a size of the new block; and a start position of the new block within the transmission frame; and
wherein the location reference of the terminating block and the location reference of the new block are configured such that the new block is overlaid on the terminating block.

10. The method of claim 9, wherein the new block is the transmitted block.

11. The method of claim 1, wherein the input port and the output port have different respective bandwidths, the size of the transmitted block and the start position of the transmitted block within the transmission frame being configured according to the bandwidth of the output port.

12. The method of claim 1, wherein the received block is a data block comprising data bits defined by a Common Public Radio Interface.

13. The method of claim 1, wherein one of the input port and the output port is a Master Port and the other is a Slave Port.

14. A computer program, configured to perform the method of claim 1 when operated by a processor.

15. A Radio Equipment, RE, device comprising:
an Open Radio equipment Interface, ORI, input port, configured to receive a data or control word block;
an ORI output port, configured to communicate a transmission frame comprising received transmitted block;
port control logic, configured to identify a location reference for the received block within the reception frame, the location reference comprising: a size of the received block; and a start position of the received block within the reception frame; and
mapping logic, configured to map the received block onto the transmission frame as the transmitted block that is identified within the transmission frame by a location reference comprising: a size of the transmitted block; and a start position of the transmitted block within the transmission frame.
